(19) United States
(12) Patent Application Publication
(10) Pub. No.: US 2026/0228600 A1
(43) Pub. Date: Aug. 6, 2026

(54) INTERFACE TEMPLATE SELECTION AND POPULATION

(71) Applicant: Walmart Apollo, LLC, Bentonville, AR (US)

(72) Inventors: Zhihao Huang, Hayward, CA (US); Abdus Saboor Khan, Santa Clara, CA (US); Afroza Ali, Los Altos, CA (US); Abhimanyu Mitra, Cupertino, CA (US); Kannan Achan, Saratoga, CA (US)

(21) Appl. No.: 19/042,158

(22) Filed: Jan. 31, 2025

(51) Int. Cl. G06N 20/00; G06F 9/451

(52) U.S. Cl. CPC G06N 20/00; G06F 9/451

(57) ABSTRACT

Example implementations related to interface template selection and population are disclosed. In an example, a plurality of rewards for optimization are received and at least one reward weight for each reward in the plurality of rewards is generated. A current reward value for each reward in the plurality of rewards is determined and a request for an interface from a user device is received. An interface template is selected using multi-objective optimization based on the current reward value and the at least one reward weight for each reward in the plurality of rewards and a set of content elements is selected based on the interface template. Instructions that cause the interface to be displayed on the user device are generated. The interface includes the interface template and the set of content elements.

### TECHNICAL FIELD

This application relates generally to interface generation, and more particularly, to interface generation using multi-objective optimization.

### BACKGROUND

Some network systems generate user interfaces by populating interface templates. A template may be populated with interface elements and transmitted to a user device for display. Multiple interface templates may be available for generating a single type of interface.

### BRIEF DESCRIPTION OF THE DRAWINGS

Various examples will be described below with reference to the following figures.

FIG. 1 depicts an example system for interface generation including selection of an interface template using multi-objective optimization, in accordance with some embodiments.

FIG. 2 depicts a system for generating one of a plurality of interfaces, in accordance with some embodiments.

FIG. 3 depicts example interfaces, in accordance with some embodiments.

FIG. 4 depicts a flow diagram illustrating an example method of generating an interface including selection of an interface template using multi-objective optimization, in accordance with some embodiments.

FIG. 5 depicts a flow diagram illustrating an example method of iteratively updating weights for selection of an interface template, in accordance with some embodiments.

FIG. 6 depicts an example system with a machine-readable medium that includes instructions for generating an interface including selection of an interface template using multi-objective optimization, in accordance with some embodiments.

FIG. 7 depicts an example system with a machine-readable medium that includes instructions for iteratively updating weights for selection of an interface template, in accordance with some embodiments.

FIG. 8 depicts an example computer system that implements one or more of the disclosed processes, in accordance with some embodiments.

### DETAILED DESCRIPTION

Some existing systems generate network interfaces (e.g., user interfaces) to enable interactions between a user device and network resources via the interface. Network systems may generate an interface by selecting an interface template and completing the template using selected interface elements or other components that may be included within the interface template. Some current network systems utilize single objective (e.g., single reward) optimization to select content for inclusion within an interface template. However, single objective optimization can reduce user engagement with a network system due to non-optimized objectives.

The disclosed systems and methods provide network interface generation using online learning with multi-objective optimization to increase user engagement opportunities and interface relevance. By optimizing multiple objectives simultaneously, the disclosed systems and methods increase resource efficiency (e.g., using fewer system resources to generate higher relevance interfaces) and increase network efficiency (e.g., providing higher relevance interfaces for users). The multi-objective optimization may utilize an initial set of weights that are updated in response to user interactions and/or session data. The multi-objective optimization generates rankings for one or more interface templates and/or one or more interface components to be included within a selected interface template.

In various embodiments, a system is disclosed. The system includes a processor and a non-transitory memory storing instructions. The instructions, when executed, cause the processor to receive at least one reward for optimization, generate a set of reward weights for a plurality of rewards including the least one reward, determine a current reward value for each reward in the plurality of rewards based on the set of reward weights, receive a request for an interface from a user device, select an interface template using multi-objective optimization based on the current reward value for each reward in the plurality of rewards, select a set of content elements based on the interface template, and generate instructions that cause the interface to be displayed on the user device. The interface includes the interface template and the set of content elements

In various embodiments, a computer-implemented method is disclosed. The computer-implemented method includes steps of receiving a plurality of reward definitions, generating a set of reward weights for each reward defined in the plurality of reward definitions, determining a current reward value for each reward defined in the plurality of reward definitions based on the set of reward weights, receiving a request for an interface from a user device, selecting an interface template using multi-objective optimization based on the current reward value for each reward defined in the plurality of reward definitions, selecting a set of content elements based on the interface template, and generating instructions that cause the interface to be displayed on the user device. The interface includes the interface template and the set of content elements.

In various embodiments, a non-transitory computer-readable medium storing instructions is disclosed. The instructions, when executed by at least one processor, cause a device to perform operations including identifying a set of rewards for optimization, generating a set of reward weights for each reward in the set of rewards, determining a current reward value for each reward in the set of rewards based on the set of reward weights, receiving a request for an interface from a user device, selecting an interface template using multi-objective optimization based on the current reward value for each reward in the set of rewards, select a set of content elements based on the interface template and the current reward value for each reward in the set of rewards, and generate instructions that cause the interface to be displayed on the user device. The interface includes the interface template and the set of content elements.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for interface generation. In various embodiments, an online learning, multi-objective optimization interface generation process optimizes multiple objectives (e.g., rewards) simultaneously when selecting an interface template and/or elements for populating the interface template. A set of reward definitions for optimization may be received and reward weights and/or a reward value for each defined reward is generated. A multi-objective optimizer receives the reward values and selects an interface template that optimizes the set of rewards. Similarly, an interface populator may apply a multi-objective optimization process to optimize selected interface elements for the interface. Instructions for generating the populated interface are provided to a user device.

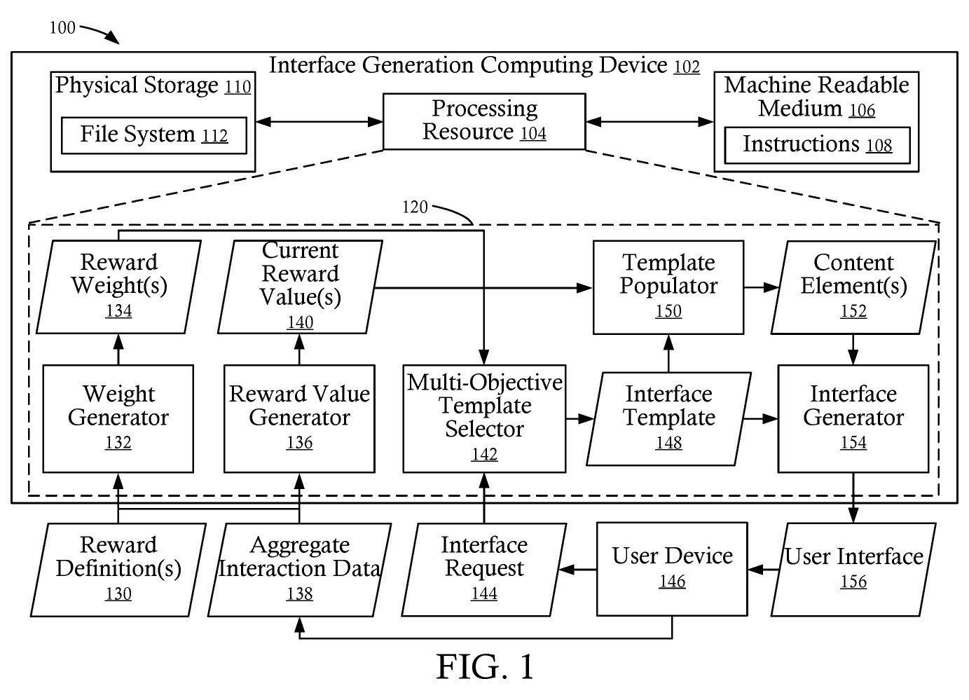

FIG. 1 depicts an example system 100 that provides multi-objective interface generation, in accordance with some embodiments. The system 100 includes an interface generation computing device 102 that provides multi-objective interface generation via a multi-objective interface generator 120. The interface generation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The interface generation computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource. The processing resource 104 may execute instructions 108 (i.e., programming or software code) stored on machine readable medium 106 to perform functions of the interface generation computing device 102, such as online learning using multi-objective optimization for interface selection. The instructions 108 may include instructions for implementing one or more models.

The interface generation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the interface generation computing device 102. In some implementations, physical storage 110 may be accessed as a block storage device.

In some cases, the interface generation computing device 102 may also include a local file system 112 that may be implemented as a layer on top of the physical storage 110. For example, an operating system may be executing on the interface generation computing device 102 (by virtue of the processing resource 104 executing certain instructions 108 related to the operating system) and the operating system may provide a file system 112 to store data on the physical storage 110.

The interface generation computing device 102 may be in communication with one or more additional devices over one or more network channels. For example, in various embodiments, the interface generation computing device 102 may be in communication with a web server, a cloud-based engine including one or more processing devices that may be provisioned for use, a database, a workstation, and/or any other suitable system or device. The interface generation computing device 102 may similarly be in communication, either directly or indirectly, with one or more user computing devices operatively coupled over the network. The other computing systems may be similar to the interface generation computing device 102, and may each include at least a processing resource and a machine readable medium.

In some embodiments, a set of reward definitions 130 is received by the multi-objective interface generator 120. For example, the reward definitions 130 may be received by a weight generator 132. The weight generator 132 generates a set of reward weights 134 including at least one weight for each reward defined in the reward definitions 130. In some embodiments, the reward weights 134 are selected, at least in part, based on values defined in the reward definitions 130 and/or aggregate interaction data 138 for the corresponding network interface. As another example, in some embodiments, the reward weights 134 are generated by applying one or more softmax calculations. Although example embodiments are discussed herein, it will be appreciated that any suitable weight generation process may be implemented by the weight generator 132 to generate the reward weights 134.

In some embodiments, the reward definitions and/or the aggregate interaction data 138 are additionally or alternatively received by a reward value generator 136 that generates a set of current reward values 140 for each reward defined in the reward definitions 130. The reward values may be generated by one or more online learning processes, such as a Thompson Sampling process, based on current session data and/or historic session data. The current reward values 140 may be generated during a current session and/or generated at a predetermined interval.

The reward weights 134 and the current reward values 140 may be provided to a multi-objective template selector 142 that selects an interface template by optimizing each of the rewards defined by the reward definitions 130. For example, the multi-objective template selector 142 may receive an interface request 144 generated by a user device. The multi-objective template selector 142 may utilize the reward weights 134, the current reward values 140, normalization, and/or one or more integrated functions to identify an interface template 148 for use in generation of the requested interface.

The selected interface template 148 may be provided to a template populator 150 that selects a set of content elements 152 for inclusion in the selected interface template 148. The template populator 150 may utilize the selected interface template 148 and one or more additional parameters and/or element selection processes to identify the set of content elements 152. For example, in some embodiments, the template populator 150 receives the reward weights 134 and/or the current reward values 140 and selects one or more of the content elements 152 using a multi-objective optimization process based on the reward weights 134 and/or the current reward values 140. As another example, in some embodiments, the template populator 150 may implement a single objective optimization process for identifying one or more of the content elements 152. Although embodiments are illustrated including a multi-objective template selector 142 and a template populator 150, it will be appreciated that the multi-objective template selector 142 and the template populator 150 may be combined into a single multi-objective selector that identifies both an interface template 148 and content elements 152 as part of one or more sequential and/or simultaneous processes.

In some embodiments, the interface template 148 and the content elements 152 are provided to an interface generator 154 that generates a user interface 156. The interface generator 154 may generate instructions that cause the user interface 156 to be displayed on a user device, such as the user device 146 that originally generated the interface request 144. The interface generator 154 may implement any suitable template completion process to populate the selected interface template 148 with the content elements 152 and/or one or more additional content elements (e.g., default content elements, user-specific content elements). In some embodiments, the interface generator 154 may implement one or more additional content selection and/or content ranking processes to select additional content elements, rank provided content elements 152, and/or otherwise populate the interface template 148. Although embodiments are illustrated including a multi-objective template selector 142, a template populator 150, and an interface generator 154, it will be appreciated that the multi-objective template selector 142, the template populator 150, and/or the interface generator 154 may be combined into a single interface generator that identifies an interface template 148 and/or content elements 152 and generates the user interface 156 as part of one or more sequential and/or simultaneous processes.

In some embodiments, the user interface 156 is provided to a user device 146 via transmission of instructions that cause the user device 146 to display the user interface 156. The user device 146 may enable interactions with the user interface 156. One or more interactions may be provided as aggregate interaction data 138 for use in updating of reward weights 134 and/or updating of current reward values 140. For example, the one or more interactions may include interactions with one or more content elements 152 that result in an updating of the reward weights 134 and/or the current reward values 140 used for a subsequent interface request 144 generated by the user device 146 and/or another user device (not shown).

As one non-limiting example, in some embodiments, a user submits an interface request 144 via a user device 146, such as a search query requesting a search result interface, on a website hosted by a web server. The web server may provide the interface request 144 to the multi-objective template selector 142 to identify a corresponding interface template 148, such as a search result interface template selected from a plurality of search result interface templates. The multi-objective template selector 142 may apply reward weights 134 and current reward values 140 in a multi-objective optimization process to identify the interface template 148. The selected search result interface template is subsequently provided to a template populator 150 that similarly utilizes the reward weights 134 and current reward values 140 to generate content elements 152, e.g., search results. An interface generator 154 generates a user interface 156 based on the selected search result interface template and the generated search results and provides the user interface to the user device 146 that generated the original interface request 144. A user may interact with the user interface 156 (e.g., select one or more of the search results) via the user device and generate interaction data, which is incorporated into aggregate interaction data 138 and utilized to update one or more of the reward weights 134 and/or one or more of the current reward values 140.

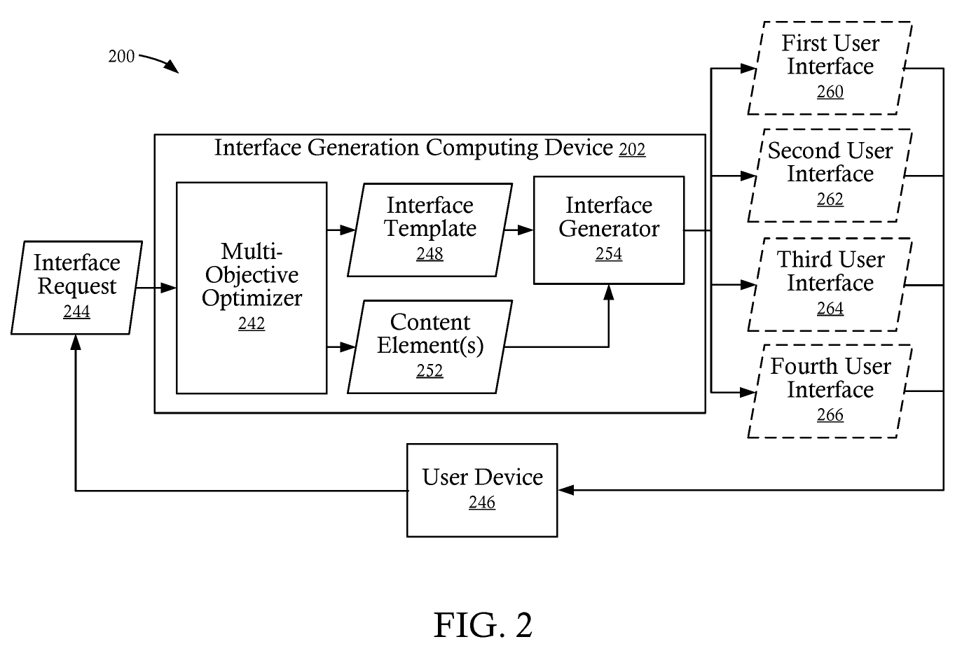

FIG. 2 depicts a system 200 for generating one of a plurality of interfaces 260-266, in accordance with some embodiments. The system 200 includes an interface generation computing device 202 that is similar to and/or may be integrated as part of the interface generation computing device 102 discussed with respect to FIG. 1. In some embodiments, an interface requests 244 is provided to the interface generation computing device 202 from a user device 246. For example, in some embodiments, an interface requests 244 may be provided to a multi-objective optimizer 242.

The multi-objective optimizer 242 may apply one or more multi-objective optimization processes to select an interface template 248 from a set of candidate interface templates and/or one or more content elements 252 from a set of candidate content elements. The interface templates and/or the content elements may be maintained in one or more data stores, such as a template data store, a catalog data store, and/or any other suitable data store.

In some embodiments, the multi-objective optimizer 242 may apply one or more additional processes prior and/or subsequent to the multi-objective optimization processes. For example, in some embodiments, the multi-objective optimizer 242 may implement an initial filtering process to narrow the set of candidate interface templates to a subset of candidate interface templates related to the interface request 244. As another example, in some embodiments, the multi-objective optimizer 242 may implement a filter process to narrow the set of candidate content elements based on a selected interface template 248 and prior to selection of the content elements 252. Although example embodiments are discussed herein, it will be appreciated that any suitable additional processes may be implemented by the multi-objective optimizer 242.

In some embodiments, the selected interface template 248 and the content elements 252 are provided to an interface generator 254, which generates an interface. The interface generator 254 may generate one of a plurality of available interfaces 260-266 based on the interface template 248 and/or the content elements 252 selected by the multi-objective optimizer 242. For example, in some embodiments, a first user interface 260 and a second user interface 262 may each be based on a first interface template but populated with different sets of content elements. Similarly, a third user interface 264 and a fourth user interface 266 may be based on different interface templates but populated with the same set of content elements. In some embodiments, the selected interface is provided to the user device 246 that initially generated the interface request 244. Although the illustrated embodiment includes four potential user interfaces 260-266, it will be appreciated that the quantity of potentially generated user interfaces is based on the quantity of interface templates and/or the quantity of content elements available for each of the interface templates and may be greater or less than the quantity illustrated.

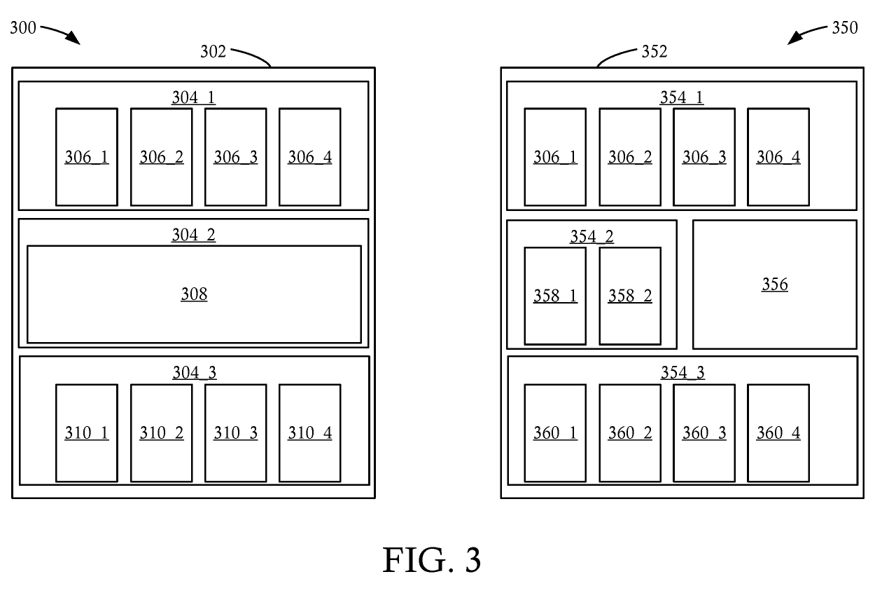

FIG. 3 depicts example interfaces 300, 350, in accordance with some embodiments. In some embodiments, a first interface 300 includes a first interface template 302 having a plurality of containers 304_1 to 304_3 (collectively “containers 304”) that may be populated with content elements. In the illustrated embodiment, a first container 304_1 is populated with a set of first content elements 306_1 to 306_4 (collectively “first content elements 306”), a second container 304_2 is populated with a second content element 308, and a third container 304_3 is populated with a set of third content elements 310_1 to 310_4 (collectively “third content elements 310”). The interface template 302 and/or each of the first content elements 306, second content element 308, and/or the third content elements 310 may be selected based on optimization of two or more objectives via a multi-objective optimization process, as discussed above with respect to FIGS. 1 and 2. The first content elements 306, second content element 308, and/or third content elements may be additionally and/or alternatively selected, at least in part, based on the interface template 302.

In some embodiments, a second interface 350 includes a second interface template 352 including a first container 354_1, a second container 354_2, a third container 354_3 (collectively “containers 354), and a fourth content element 356. The fourth content element 356 may include a template-specific content element and/or a content element selected via one or more content selection processes, such as a multi-objective optimization process as discussed above. As illustrated in FIG. 3, in some embodiments, the first container 354_1 of the second interface 350 includes the same set of first content elements 306 as the first container 304_1 of the first interface 302. The second container 354_2 includes a set of fifth content elements 358_1, 358_2 (collectively “fifth content elements 358) and the third container 354_3 includes a set of sixth content elements 360_1 to 360_4 (collectively “content elements 360”). Although certain embodiments are illustrated herein, it will be appreciated that any suitable template may be generated by a multi-objective optimization process based on one or more interface templates and/or one or more content elements.

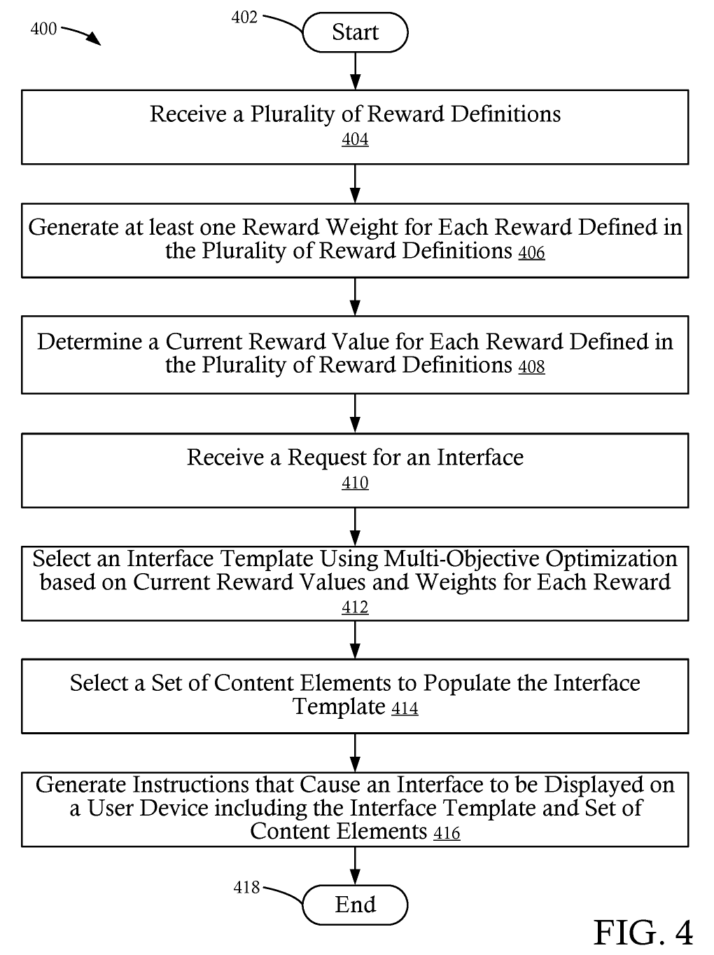

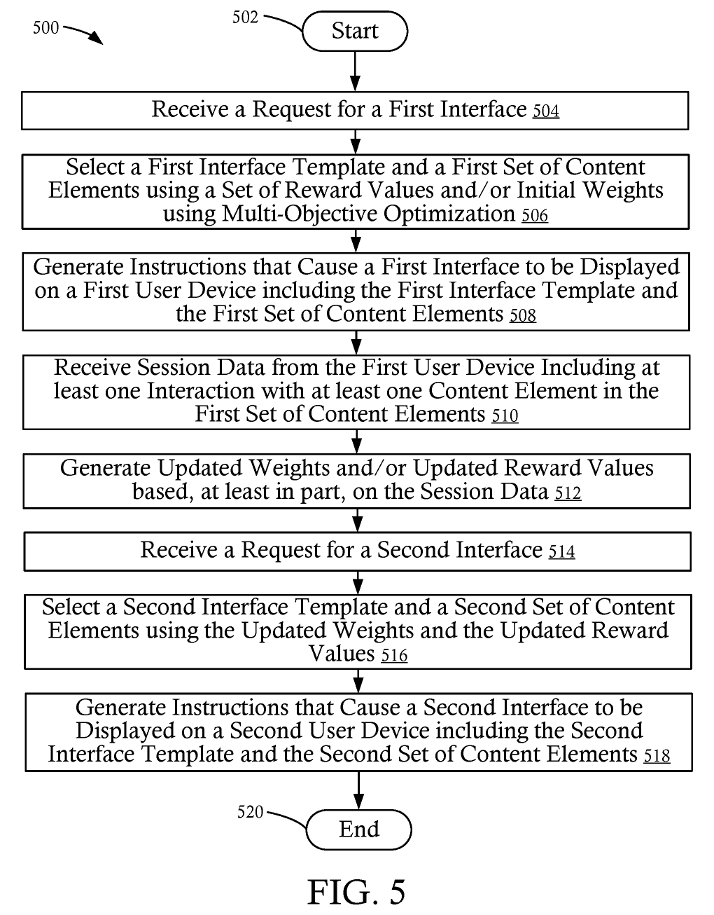

FIGS. 4 and 5 are flow diagrams depicting example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 4 and 5 may be implemented in the form of executable instructions stored on a machine-readable medium and executed by a processing resource and/or in the form of electronic circuitry. For example, aspects of the methods may be described below as being performed by an interface generation process, an example of which may be the multi-objective interface generator 120 running on a hardware processing resource 104 of the interface generation computing device 102 described above. Additionally, other aspects of the methods described below may be described with reference to other elements shown in FIG. 1 for non-limiting illustration purposes.

FIG. 4 depicts a flow diagram illustrating an example method 400 of generating an interface including selection of an interface template using multi-objective optimization, in accordance with some embodiments. Method 400 starts at block 402 and continues to block 404, where a plurality of reward definitions are received. At block 406, a set of reward weights including at least one weight for each reward defined in the plurality of reward definitions is generated. For example, the reward definitions may be received by a weight generator that generates a set of reward weights including at least one weight for each reward defined in the reward definitions. In some embodiments, the reward weights are selected, at least in part, based on values defined in the reward definitions and/or aggregate interaction data for the corresponding network interface. As another example, in some embodiments, the reward weights are generated by applying one or more softmax calculations.

At block 408, a current reward values for each reward defined in the plurality of reward definitions is determined. The reward values may be determined by one or more online learning processes, such as a Thompson Sampling process, based on current session data and/or historic session data. The current reward values may be generated during a current session and/or generated at a predetermined interval.

At block 410, a request for an interface is received. The request may be received from any suitable system, such as a user device. In some embodiments, the request may be in the form of a network operation request, such as a search query submission or an item selection.

At block 412, an interface template is selected using multi-objective optimization based on the current reward values and the reward weights for each reward defined in the plurality of reward definitions. In some embodiments, the multi-objective optimization utilizes the reward weights, the current reward values, normalization, and/or one or more integrated functions to identify an interface template for use in generation of the requested interface.

At block 414, a set of content elements is selected to populate the interface template selected at block 412. The set of content elements may be selected based on the previously selected interface template and/or using multi-objective optimization based on the reward weights generated at block 406 and/or the current reward values generated at block 408. In some embodiments, the set of content elements may include generic and/or default content elements selected without consideration of the interface template, the reward weights, and/or the current reward values.

At block 416, instructions are generated that cause an interface to be displayed on a user device. The displayed interface includes at least the interface template and the set of content elements. The set of content elements may be populated within one or more containers defined by the interface template. The displayed interface includes an interface that optimizes each of the rewards defined by the reward definitions to increase user engagement with the network system. At block 418, the method 400 ends.

FIG. 5 depicts a flow diagram illustrating an example method 500 of iteratively updating weights for selection of an interface template, in accordance with some embodiments. Method 500 starts at block 502 and continues to block 504, where a request for a first interface is received. The request may be received from any suitable system or device, such as a first user device. At block 506, a first interface template and a first set of content elements are selected using a first set of reward values and/or a first set of weights using multi-objective optimization. For example, the first interface template and the first set of content elements may be selected according to blocks 404 to 414 discussed above with respect to FIG. 4.

At block 508, instructions are generated that cause a first interface to be displayed on a first user device. The first interface includes the first interface template and the first set of content elements. For example, the first interface may include the first interface template populated with the first set of content elements and, optionally, one or more additional content elements. The instructions may be provided to the first user device.

At block 510, session data is received from the first user device. The session data includes at least one interaction with at least one content element in the first set of content elements. For example, in some embodiments, a user may interact with the first interface via the first user device to interact with (e.g., select, click-on) one or more displayed interface elements, including at least one content element in the first set of content elements. The session data may include general session data and/or specifically generated feedback data regarding interactions with the generated first interface.

At block 512, a set of updated weights and/or a set of updated reward values are generated based, at least in part, on the session data. For example, the initial weights used at block 506 may be updated in response to additional aggregated interaction data that includes the session data. The weights may be updated to reflect a change in user behaviors, a change in optimization priorities, and/or to reflect any other system change. Similarly, the set of reward values utilized at block 506 may be updated in response to the session data to reflect changes in user interactions, reward incentives, and/or other user trends.

At block 514, a request for a second interface is received. The request for the second interface may be received from any suitable system or device, such as the first user device or a second user device. At block 516, a second interface template and a second set of content elements is selected using the updated weights and/or the updated reward values using multi-objective optimization. For example, the second interface template and the second set of content elements may be selected according to blocks 412 and 414 discussed above with respect to FIG. 4 utilizing the updated weights and updated reward values at each corresponding block.

At block 518, instructions are generated that cause a second interface to be displayed on a user device, such as the second user device. The second interface includes the second interface template and the second set of content elements. For example, the second interface may include the second interface template populated with the second set of content elements and, optionally, one or more additional content elements. The instructions may be provided to the second user device. At block 520, the method 500 ends.

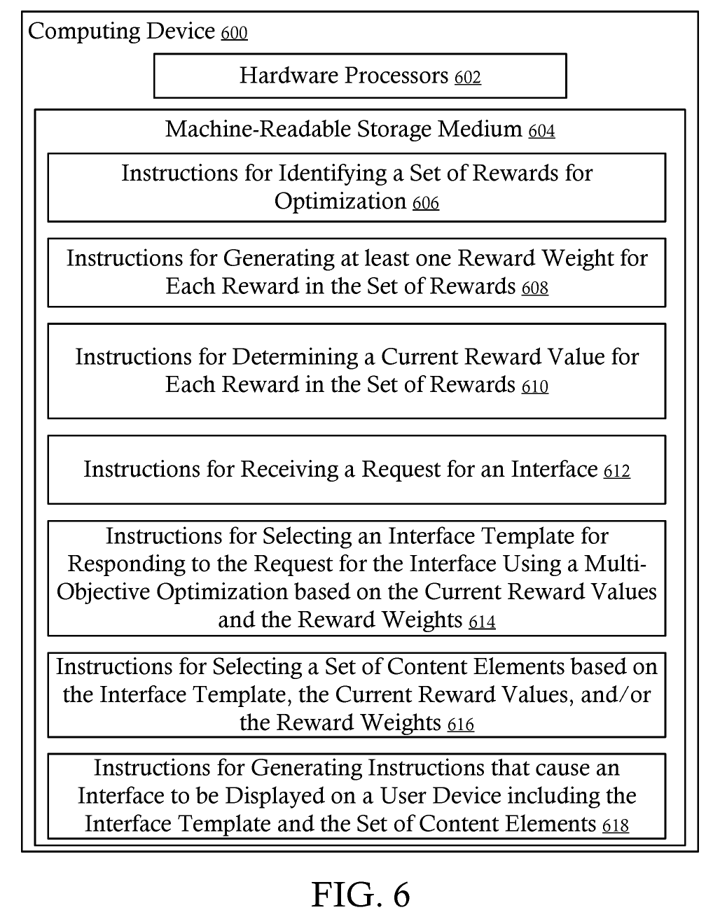

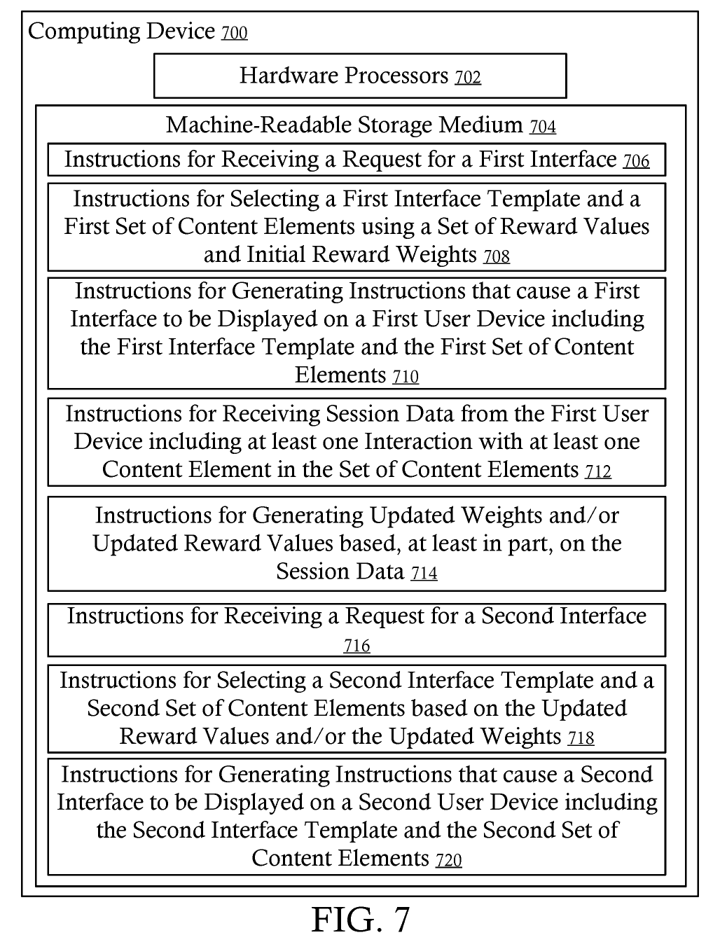

FIGS. 6 and 7 depict example systems 600, 700, respectively, that include non-transitory, machine-readable medium 604, 704, respectively, encoded with example instructions executable by processing resources 602, 702, respectively. In some implementations, the systems 600, 700 may be useful for implementing aspects of the multi-objective interface generator 120 of FIG. 1, the system 200 of FIG., or for performing aspects of methods 400, 500 of FIGS. 4 and 5, respectively. For example, the instructions encoded on machine-readable medium 604, 704 may be included in instructions 108 of FIG. 1. In some implementations, functionality described with respect to FIG. 1 may be included in the instructions encoded on machine-readable medium 604, 704.

The processing resources 602, 702 may include a microcontroller, a microprocessor, central processing unit core(s), an ASIC, an FPGA, and/or other hardware device suitable for retrieval and/or execution of instructions from the machine-readable medium 604, 704 to perform functions related to various examples. Additionally or alternatively, the processing resources 602, 702 may include or be coupled to electronic circuitry or dedicated logic for performing some or all of the functionality of the instructions described herein.

The machine-readable medium 604, 704 may be any medium suitable for storing executable instructions, such as RAM, ROM, EEPROM, flash memory, a hard disk drive, an optical disc, or the like. In some example implementations, the machine-readable medium 604, 704 may be a tangible, non-transitory medium. The machine-readable medium 604, 704 may be disposed within the systems 600, 700, respectively, in which case the executable instructions may be deemed installed or embedded on the system. Alternatively, the machine-readable medium 604, 704 may be a portable (e.g., external) storage medium, and may be part of an installation package.

As described further herein, the machine-readable medium 604, 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 6 and 7.

With reference to FIG. 6, the machine-readable medium 604 includes instructions 606-618. Instructions 606, when executed, cause the processing resource 602 to identify a set of rewards for optimization. The set of rewards may be identified according to one or more received reward definitions.

Instructions 608, when executed, cause the processing resource 602 to generate at least one reward weight for each reward in the set of rewards. For example, the set of rewards may be provided to a weight generator that generates a set of reward weights including at least one weight for each reward. In some embodiments, the reward weights are selected, at least in part, based on aggregate interaction data for the corresponding network interface. As another example, in some embodiments, the reward weights are generated by applying one or more softmax calculations.

Instructions 610, when executed, cause the processing resource 602 to determine a current reward value for each reward in the set of rewards. The reward values may be determined by one or more online learning processes, such as a Thompson Sampling process, based on current session data and/or historic session data. The current reward values may be generated during a current session and/or generated at a predetermined interval.

Instructions 612, when executed, cause the processing resource 602 to receive a request for an interface. The request may be received from any suitable system, such as a user device. In some embodiments, the request may be in the form of a network operation request, such as a search query submission or an item selection.

Instructions 614, when executed, cause the processing resource 602 to select an interface template using multi-objective optimization based on the current reward values and the reward weights for each reward in the set of rewards. In some embodiments, the multi-objective optimization utilizes the reward weights, the current reward values, normalization, and/or one or more integrated functions to identify an interface template for use in generation of the requested interface.

Instructions 616, when executed, cause the processing resource 602 to select a set of content elements to populate the interface template selected at block 412. The set of content elements may be selected based on the previously selected interface template and/or using multi-objective optimization based on the generated reward weights and/or the generated current reward values. In some embodiments, the set of content elements may include generic and/or default content elements selected without consideration of the interface template, the reward weights, and/or the current reward values.

Instructions 618, when executed, cause the processing resource 602 to generate instructions that cause an interface to be displayed on a user device. The displayed interface includes at least the interface template and the set of content elements. The set of content elements may be populated within one or more containers defined by the interface template. The displayed interface includes an interface that optimizes each of the rewards defined by the reward definitions to increase user engagement with the network system.

With reference to FIG. 7, the machine-readable medium 704 includes instructions 706-720. Instructions 706, when executed, cause the processing resource 702 to a receive request for a first interface. The request may be received from any suitable system or device, such as a first user device.

Instructions 708, when executed, cause the processing resource 702 to select a first interface template and a first set of content elements using a first set of reward values and/or a first set of weights using multi-objective optimization.

Instructions 710, when executed, cause the processing resource 702 to generate instructions that cause a first interface to be displayed on a first user device. The first interface includes the first interface template and the first set of content elements. For example, the first interface may include the first interface template populated with the first set of content elements and, optionally, one or more additional content elements. The instructions may be provided to the first user device.

Instructions 712, when executed, cause the processing resource 702 to receive session data from the first user device. The session data includes at least one interaction with at least one content element in the first set of content elements. For example, in some embodiments, a user may interact with the first interface via the first user device to interact with (e.g., select, click-on) one or more displayed interface elements, including at least one content element in the first set of content elements. The session data may include general session data and/or specifically generated feedback data regarding interactions with the generated first interface.

Instructions 714, when executed, cause the processing resource 702 to generate a set of updated weights and/or a set of updated reward values based, at least in part, on the session data. For example, the initial weights may be updated in response to additional aggregated interaction data that includes the session data. The weights may be updated to reflect a change in user behaviors, a change in optimization priorities, and/or to reflect any other system change. Similarly, the set of reward values may be updated in response to the session data to reflect changes in user interactions, reward incentives, and/or other user trends.

Instructions 716, when executed, cause the processing resource 702 to receive a request for a second interface. The request for the second interface may be received from any suitable system or device, such as the first user device or a second user device.

Instructions 718, when executed, cause the processing resource 702 to select a second interface template and a second set of content elements based on the updated weights and/or the updated reward values using multi-objective optimization.

Instructions 720, when executed, cause the processing resource 702 to generate instructions that cause a second interface to be displayed on a user device, such as the second user device. The second interface includes the second interface template and the second set of content elements. For example, the second interface may include the second interface template populated with the second set of content elements and, optionally, one or more additional content elements. The instructions may be provided to the second user device.

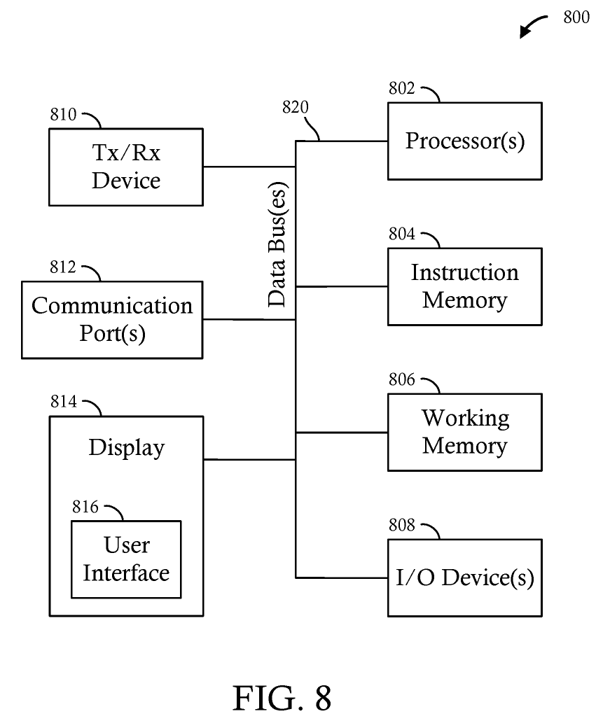

FIG. 8 illustrates a block diagram of a computing device 800, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device.

As shown in FIG. 8 the computing device 800 may include one or more processing resources 802, instruction memory 804, working memory 806, input/output devices 808, transceiver 810, communication ports 812, display 814, and/or any other suitable elements each operatively coupled to one or more data buses 820. The data buses 820 allow for communication among the various components. The data buses 820 may include wired, or wireless, communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an application specific integrated circuit (ASIC), a field programmable gate array (FPGA), a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for interface generation using multi-objective optimization, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in the instruction memory 804. In some embodiments, the communication port(s) 812 allow for the transfer (e.g., uploading or downloading) of data, such as machine learning model training data.

In some embodiments, the communication port(s) 812 couples the computing device 800 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display, and may display the user interface 816. The user interfaces 816 may include interfaces generated by multi-objective optimization. For example, the user interface 816 may be a user interface for an application of a network environment operator that allows a user to view and interact with the operator’s website. In some embodiments, a user may interact with the user interface 816 by engaging the input/output devices 808. In some embodiments, the display 814 may be a touchscreen, where the user interface 816 is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

In some embodiments, the computing device 800 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub- modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more graphical processing units (GPUs), one or more central processing units (CPUs), and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that identification of interface templates and content elements as disclosed herein, particularly on large datasets intended to be used network systems, is only possible with the aid of computer-assisted machine-learning algorithms and techniques, such as multi-objective optimization processes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a plurality of rewards for optimization;
generate at least one reward weight for each reward in the plurality of rewards;
determine a current reward value for each reward in the plurality of rewards;
receive a request for an interface from a user device;
select an interface template using multi-objective optimization based on the current reward value and the at least one reward weight for each reward in the plurality of rewards;
select a set of content elements based on the interface template; and
generate instructions that cause the interface to be displayed on the user device, wherein the interface includes the interface template and the set of content elements.

2. The system of claim 1, wherein the current reward value for each reward in the plurality of rewards is determined by an online learning process.

3. The system of claim 2, wherein the online learning process is a Thompson Sampling process.

4. The system of claim 1, wherein the multi-objective optimization optimizes at least two rewards in the plurality of rewards, normalizes the current reward value for each reward in the plurality of rewards, and applies an integrated function.

5. The system of claim 1, wherein the current reward value for each reward in the plurality of rewards is determined based at least in part on interaction data for a current time period.

6. The system of claim 1, wherein the instructions cause the processor to:
receive current session data including at least one interaction with at least one content element of the set of content elements;
generate an updated current reward value for at least one reward in the plurality of rewards based at least in part on the current session data;
receive a request for a subsequent interface; and
select a subsequent interface template using the multi-objective optimization based at least in part on the updated current reward value.

7. The system of claim 6, wherein the interface template and the subsequent interface template are different.

8. The system of claim 1, wherein the at least one reward weight is generated by a softmax determination.

9. A computer-implemented method, comprising:
receiving a plurality of reward definitions;
generating at least one reward weight for each reward defined in the plurality of reward definitions;
determining a current reward value for each reward defined in the plurality of reward definitions;
receiving a request for an interface from a user device;
selecting an interface template using multi-objective optimization based on the current reward value and the at least one reward weight for each reward defined in the plurality of reward definitions;
selecting a set of content elements to populate the interface template; and
generating instructions that cause the interface to be displayed on the user device, wherein the interface includes the interface template and the set of content elements.

10. The computer-implemented method of claim 9, wherein the current reward value for each reward defined in the plurality of reward definitions is determined by an online learning process.

11. The computer-implemented method of claim 10, wherein the online learning process is a Thompson Sampling process.

12. The computer-implemented method of claim 9, wherein the multi-objective optimization optimizes at least two rewards defined in the plurality of reward definitions, normalization of the current reward value for each reward, and applies an integrated function.

13. The computer-implemented method of claim 9, wherein the current reward value for each reward defined in the plurality of reward definitions is determined based at least in part on interaction data for a current time period.

14. The computer-implemented method of claim 9, comprising:
receiving current session data including at least one interaction with at least one content element of the set of content elements;
generating at least one updated weight or at least one updated reward value for at least one reward defined in the plurality of reward definitions based at least in part on the current session data;
receiving a request for a subsequent interface; and
selecting a subsequent interface template using the multi-objective optimization based at least in part on the at least one updated weight or the at least one updated reward value.

15. The computer-implemented method of claim 14, wherein the interface template and the subsequent interface template are different.

16. A non-transitory computer-readable medium storing instructions that, when executed by at least one processor, cause a device to perform operations comprising:
identifying a set of rewards for optimization;
generating at least one reward weight for each reward in the set of rewards;
determining a current reward value for each reward in the set of rewards;
receiving a request for an interface from a user device;
selecting an interface template using multi-objective optimization based on the current reward value and the at least one reward weight for each reward in the set of rewards;
select a set of content elements based on the interface template; and
generate instructions that cause the interface to be displayed on the user device, wherein the interface includes the interface template and the set of content elements.

17. The non-transitory computer-readable medium of claim 16, wherein the current reward value for each reward in the set of rewards is determined by a Thompson Sampling process.

18. The non-transitory computer-readable medium of claim 16, wherein the multi-objective optimization optimizes the set of rewards, normalization of the current reward value for each reward in the set of rewards, and a selected integrated function.

19. The non-transitory computer-readable medium of claim 16, wherein the current reward value for each reward in the set of rewards is determined based at least in part on interaction data for a current time period.

20. The non-transitory computer-readable medium of claim 16, wherein the instructions cause the device to perform operations comprising:
receiving current session data including at least one interaction with at least one content element of the set of content elements;
generating an updated current reward value for at least one reward in the set of rewards based at least in part on the current session data;
receiving a request for a subsequent interface; and
selecting a subsequent interface template using the multi-objective optimization based on the updated current reward value.
